(19) United States
(12) Patent Application Publication
(10) Pub. No.: US 2018/0204146 A1
(43) Pub. Date: Jul. 19, 2018

(54) AUTOMATED REBOOKING SYSTEM AND METHOD FOR AIRLINES

(71) Applicant: WNS GLOBAL SERVICES PRIVATE LIMITED, Mumbai (IN)

(72) Inventor: BAIJU SHAFFI, Mumbai (IN)

(73) Assignee: WNS GLOBAL SERVICES PRIVATE LIMITED, Mumbai (IN)

(21) Appl. No.: 15/736,289

(22) PCT Filed: May 13, 2015
(86) PCT No.: PCT/IB2015/053523

§ 371 Date: Dec. 13, 2017

(51) Int. Cl. G06Q 10/02; G06Q 30/00; G06Q 50/30; G06Q 50/14

(52) U.S. Cl. CPC G06Q 10/025; G06Q 50/14; G06Q 50/30; G06Q 30/016

(57) ABSTRACT

The invention describes a system and method to rebook passengers using an airline reservation system. Information about a flight disruption event, like a delayed or cancelled flight, is received from several sources such as Airline Reservation System, Hotel Reservations, Business rules and airline policies and communication platforms. The passengers are prioritized based on the booking conditions for each passenger, such as class of service, FFP status, type of passenger, passengers requiring special handling. Thereafter re-booking is done for the affected passengers based on defined business rules set out by the airlines, such as passenger-class, origin and destination pair, airline availability, ticketing agreements between airlines and re-booking module selects an airline and respective-class of booking as per policies laid down by such airline.

### BACKGROUND

### Field of the Invention

Embodiments of the present invention generally relate to field of travel reservations, and, more specifically, to a system and method that automates upon flight schedule change and disruptions covering rebooking flights, ticketing, hotel booking, communication, compensation, refunds, meal and airport lounge vouchers.

### Description of the Related Art

When flights get delayed or cancelled last minute due to unplanned events (flight disruption), such as weather, airline glitches, crowded skies, late arrival of incoming flights, security measure, etc, the affected passengers are to be rebooked on to alternate flights, so that they can reach their final destination with minimum inconvenience. The number of passengers affected could be all or part of the passengers in the flight and such travelers to be rebooked to their final destination with best possible options. Today, re-accommodating passengers due to disruption is mostly a manual process handled by airline staff at the airport, call centers or operations control on ad hoc basis based on availability of skilled staff. Airline staff looks at each passenger's itinerary (PNR) and rebook alternate options manually and then reissue/revalidate tickets. Since this is an unplanned activity with limited number of staff and without automation, the process of rebooking a single flight takes lot of time. Due to this an airline may lose opportunity to rebook the passengers in immediately available next flights as well as passengers are not informed about the delay or cancellation or options protected for them in a proactive manner leading to further customer inconvenience and dissatisfaction. When the disruption happens, airlines take many hours to rebook passengers in alternate flight/s and they also struggle to inform passengers about delays or options due to lack of dedicated staff or technology platforms. All this leads to passengers reaching the airport or passengers already at the airport struggling to find their alternate options. This gets more complicated when changes happen during after office hours or weekends when the resources are limited leading to more pressure on airline operations and further increasing customer inconvenience.

FIG. 1 is a flow diagram depicting a typical impact of a flight disruption, as per the current state of art. The airport staff and or airline contact center is informed about the delay and they in turn look at each passenger's booking separately as the impact will be different for each of them depending on the origin and destination of their itinerary—some passengers are booked to connect from another flight to the affected flight, some passengers just booked to travel only on the affected flight/sector and some people are booked on the affected flight with onward connections. Due to this complexity, each booking has to be treated separately and rebooked manually by the airline staff in the airline reservation system after considering the airline rebooking policies and availability of flights. Post rebooking, they also manually reissue or revalidate the ticket so that the rebooked flight/airline will have passenger's revised ticket details along with booking. Based on the revised flight times some or all of the passengers have to be provided hotel accommodation either at departure or transit point depending on the delayed hours. Booking of the hotel is again a manual activity by directly calling the hotel or using a reservation system Also, some or all of the passengers to be issued meal/airport lounge vouchers depending on the delay and these are paper documents issued manually. Currently, there is no structured practice to handle the impact of flight disruption and it is handled by airline staff at airport or contact centers or operational control on ad-hoc basis depending on the availability of manpower. Most of the airline direct staff and their outsourced ground handling support staff at the airport are not trained and equipped to handle disruption from rebooking perspective and this coupled with frontline staff's poor understanding of disruption policies and no decision making powers will add to the inefficient handling of the situation. All this and poor automation in this area leads to time consuming rebooking process, inability to provide end to end rebooking option, non-prioritizing passengers based business rules and individual requirements, Special Services Requests not being met and booking with other airlines where there is no special commercial agreements are in place resulting in poor customer experience and revenue loss for airline and passengers. Apart from airlines direct distribution systems (airline offices, call centers and website), airlines receives passenger bookings through Travel Agents—Brick and Mortar as well as Online Travel. When schedule change happens to booking made by Travel agents, these PNRs are queued back to the respective Travel Agents' offices using GDS queues. Travel agents then subsequently have to manually process these PNRs based on airline and agency policies and reissue tickets so that their passengers can travel to the end destination with minimum impact. This is a complex manual process for agents as they get such PNRs from multiple airlines and each booking has to be handled as per respective airline policy as well as the agency policy and customer requirements. Apart from passengers, these agents also have to reach out to airlines to get policy clarity, approval for re-booking, etc and thus adding further pressure on airline operations departments as well as travel agency operations.

Today, a single disruption rebooking can take hours or even full day, and could be a stretch on resources, as there are no dedicated trained teams to handle a disruption. The impact results in revenue loss due to non-adherence to procedures, processes and not meeting customer requirements: non-adherence to rebooking policies, rebooking with other airlines, ground transportation, accommodation, compensation, passenger not taking the rebooked flights, refunds, etc. There may also be lost opportunity to rebook to immediately available flights due to delayed decision making/action. This also results in multiple customer dissatisfaction points due to not managing customer journey seamlessly.

Our search at US & European Patent Database reveals several pending and issued patents relating to the specific application around the airline reservation systems.

US Patent No. 20040039615 A1 by Higinio Maycotte, Michael Scott, James Stanislaus, Ernesto Vazquez is titled as ‘Automated collection of flight reservation system data’. The invention describes a system comprising a customer reservation subsystem. The system also comprises an external communication subsystem responsive to the disruption prediction subsystem. The system also includes an alternate travel solution subsystem responsive to the disruption prediction subsystem and providing input to the external communication subsystem.

PCT Application no WO 2013082151 A1 by Tatevik SHAHBAZIAN, Sargis MAKARYAN is titled as Layover management system and method. The patent describes method or system for reservation and booking of hotel rooms per hour, conference rooms at hotels per hour, sightseeing activities, rental cars or equipment per hour, and other services per hour (such as WIFI, SPA services at hotels nearby, etc.) for a layover (the time that available between arriving flight and boarding the next flight), or in the case of flight delays or flight cancellation, detecting such condition and sending notification to the client via email, SMS, or application push notification with suggestion of booking of aforementioned products or services.

PCT Application No WO 2013028903 A2 by Stephen C. DENISON et al is titled as ‘Travel arrangement service and method of determining alternative routes’. The invention describes a method that includes receiving flight information relating to a flight of a travel itinerary, querying a flight data system for alternative flight information and obtaining alternative flight information relating to an alternative flight, creating an alternative flight set from the alternative flight information and processing the alternative flight set to create a prioritized list of alternative travel options. At least a part of the prioritized list is sent to a computing device that is accessible to a passenger or the agent of the passenger, and a selection from the prioritized list is received in return. The travel itinerary of the passenger is modified at least in part based on the selection from the prioritized list.

Despite the existence of several related art, the challenge still remains to handle the flight disruptions by fully automating the rebooking process for airline passengers.

### SUMMARY OF THE INVENTION

Aspect of the present invention is to provide for an “on demand” solutions that integrate with airline booking system to process schedule change/cancelled flights and rebook them based on defined business rules.

Another aspect of the solution is to monitor flight schedule changes or cancellations across airline network and inform respective airline offices on a real time basis through SMS/E-MAIL & airline telex so that the airline staff can take necessary action.

Another aspect of the present invention is to provide for an automated module to identify affected passengers and prioritize them based on—Class of service, Frequent Flyer Program status, Passengers requiring special handling, etc (Configurable/customizable passenger prioritization rules).

One more aspect of the present invention is to provide a standard way for booking the passengers based on: same airline, group airlines, alliance partners, Special Agreement with Other Airlines and others (Adhering to airline rebooking policies for better journey management with minimal commercial impact for the airline)

Another option is to provide a link along with the rebooked itinerary option by the airline when the e-mail or SMS update send to the passenger and the link will provide real time alternate flight options. If the passengers are not happy with the automated option, they can select an option from the link and confirm the same from a computer or smart phone instantly themselves.

Another aspect of the application is the travel agent module which automate the rebooking of schedule change bookings from travel agents' GDS queue based on each PNR, respective airline and agency policies.

One more aspect of the invention is to provide tickets revalidation or reissuance followed by SMS and E-mail being sent out.

Another aspect of the invention is to enable communication to airline offices: Email/Telex and real time web access to access to see the rebooking status, passenger level itineraries, rebooking and communication status, other details and reports.

Another feature is to auto calculation of compensation (Eg:—European Union Flight delay/cancellation compensation) to be provided to the passengers and providing the reports to the airlines for action.

Another aspect is the option for the airline staff to issue vouchers for affected passengers to be used for restaurants or lounges at the airports.

Another aspect of the invention to enable refunds on priority using refund processor for passengers who are affected and would prefer to go for a refund instead of going ahead with the journey

Another aspect is to auto identification of passengers who are to be booked hotels at departing city or transit point due to long waiting period. Book the hotels automatically and sending hotel vouches through e-mail to the passenger, airline staff and hotel.

Another aspect of the intervention is providing real time and historical data, MIS and analysis on flight disruption so that airlines can plan and take informed decisions.

Other aspects, advantages, and salient features of the invention will become apparent to those skilled in the art from the following detailed description, which, taken in conjunction with the annexed drawings, disclose exemplary embodiments of the invention.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram depicting a typical impact of a flight disruption, as per the current state of art.

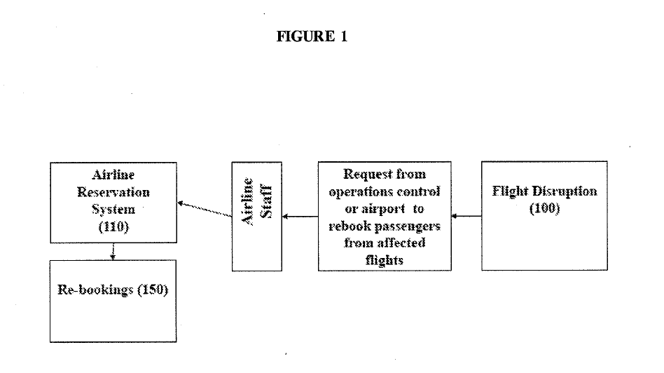

FIG. 2 is a flow diagram of a system for providing an automated rebooking module, according to one or more embodiments of the present invention;

FIG. 3 is a flow diagram of a system for providing services to an airline's automated rebooking module, according to one or more embodiments of the present invention.

FIG. 4 is a block diagram depicting an automated rebooking system, according to one or more embodiments of the present invention.

### DETAILED DESCRIPTION

In the present description, some words are being used interchangeably to mean the same thing/entity: ‘Passengers’, ‘Customers’ & ‘Users’; ‘He’ & “She”.

It is appreciated that present invention can be implemented in a variety of systems, devices, architectures and configurations. For example, it can be used as an application with several known platforms, such as for, Airline Reservation Systems, Global Distribution Systems, Passenger Services Systems, Computer reservation Systems, web based platforms, mobile platforms (iOs, Android, Windows), distributed computing environment, a cloud computing environment, a client server environment, social networking websites, etc. Embodiments described herein may also be discussed in the general context of computer-executable instructions residing on some form of computer-readable storage medium, such as program modules, executed by one or more computers, computing devices, or other devices.

Particularly, the rebooking system and method is an automated solution that integrates with airline booking system or GDS or PSS at user interface or web services or API or Queue levels to process schedule change/cancelled flights and rebooking based on defined business rules.

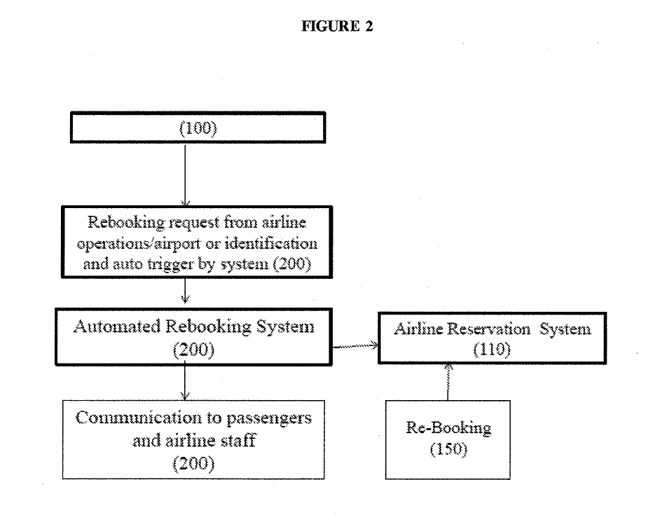

FIG. 2 is a flow diagram of a system for providing an automated rebooking module, according to one or more embodiments of the present invention. The trigger to initiate the automated rebooking module is a flight disruption event, like early departure, delay or cancellation of the flight. This trigger may be automated or manual. The application can be activated automatically based on flight delay/cancellation trigger or manually by inputting the affected flight details or it may be identification and auto trigger by system. Once the system is activated, it will search and identify all affected passengers and then prioritize them for rebooking based on various airline business rules (class of travel, frequent flyer status, people with special needs—wheel chair passengers, medical passengers, people traveling with infants, etc.). Post prioritization, the system will auto select the best flight option for each passenger/PNR based on origin and destination principle and rebook flights and confirm hotels if required based on rules. The rules can be based on class of service, frequent flyer status, type of passenger, origin and destination, airlines available for rebooking, airline policies and agreements on rebooking, number of hours of delay or transit duration, whether compensation to be paid to passengers or not, etc. Once rebooked, the information may also be sent in several preferred ways to the affected passengers that may be via Email, text message, phone calls, social media, etc.

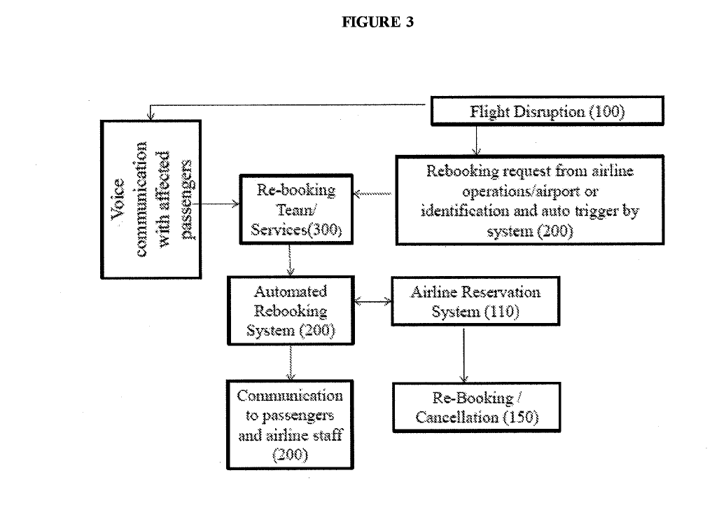

FIG. 3 is a flow diagram of a system for providing services (300) to an airline's automated rebooking module, according to one or more embodiments of the present invention. The automated rebooking module is based on inputs form the team that specializes for a particular airline policies and procedures. As all airlines will come out with the new policies and procedures from time to time, such services can benefit the automated airline rebooking module, to be more customized for each flight disruption as well as improving the overall customer experience during the flight disruption.

Based on flight delay or cancellation confirmation, agents input flight details into the automated rebooking system. The system identifies affected passengers and prioritizes them based on—Class of service, FFP status, Passengers requiring special handling, etc. Thereafter passengers are booked based O&D and the airline selections are based on: same airline, group airlines, alliance partners, SPA and others. Accordingly, SSR is updated. After the rebooking is done, tickets are revalidated or reissued and SMS/E-mail sent out if the hotel is not required. Passengers requiring hotel bookings are identified on the basis of delayed hours, transit time, class of service, etc. and hotels selected based on preferred, negotiated rates, etc. and customer type (e.g. First Class, Economy Class, Executive Club etc.). Post hotel confirmation, SMS/E-mail sent to customer with flight & hotel details. PNRs rejected by the system are sent for manual processing by the agents. Communication to airline offices: Email/Telex/Mobile Apps and real time web access to see the rebooking status, details and reports. Refunds are processed on priority using refund processor. European Union/any other mandatory compensation are calculated and reported out on real time basis enabling airlines to pay the customers near real time basis and improve the customer experience or use it as data point to manage future claims or pay outs.

The services teams also pick any PNRs rejected by the automated rebooking system due to various reasons and process them manually. They also make outbound calls to customers to inform about the changes as well as handle incoming customer queries related the disruption and any changes required to the booking as per customer requirement.

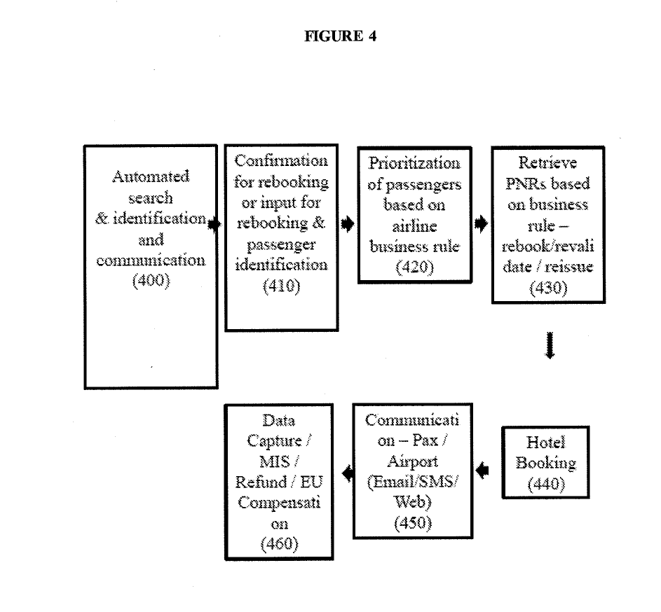

FIG. 4 is a block diagram depicting an automated rebooking system, according to one or more embodiments of the present invention. The rebooking system can monitor and identify disrupted flights of an airline on a real time basis. As soon as it detects a disrupted flight, it seeks confirmation on rebooking by sending out e-mail/sms/airline telex to the respective airline departments. On rebooking approval from relevant personnel, affected PNRs are identified and passengers are prioritized based on the airline policies and procedures. The prioritized PNRs are rebooked, revalidated and reissued. Depending on circumstances, when passengers have to wait for more than a time specified by the airline at the departing city or a transit point due to alternate flight option availability, the system will identify such passengers who need to be provided with accommodation as per airline policy. Based on this, the system will do an automated Hotel bookings for affected passengers based on predefined parameter. The system will send out a communication via several preferable means like an email, SMS, Web based, social media, mobile apps and also capture and store the data. It also has a feature whereby it calculates and store the compensation amount to be paid to the affected passengers based on legal jurisdiction and individual carrier policies. The system integrates with Airline Systems and track delays and cancellation if such changes are updated by the airline in their respective systems. Once it identifies changes, it sends out an email or SMS that this flight is getting delayed, and seeks approval from the Airline to do an automated rebooking. If there is a sign off on automated bookings, the flight details are entered into the tool that pulls out the details of all passengers who will be affected by such delays. The system looks at Airline rules, for example business class passengers be booked first and then followed by economy class. If there are frequent flyer members or passengers require special assistance, they may be prioritized over others, etc. All these rules are set in the application based on airline policies on prioritization.

Once the passengers are prioritized, the system will look into policies surrounding the re-bookings. For example, if the British Airways flight is delayed, it will look for an alternative British Airways flights available for a given destination. This is done to avoid revenue loss by booking in other airlines. If the same airline is not available, the system starts looking for its Alliance/partner Airlines. If the alliances/partners are unavailable, the system can start looking for alternate airlines where the affected airlines have special Prorate agreements (SPA). If SPA airlines also not available it looks for others depending on the airline selection policies defined in the tool. Once the passengers are booked, the system will automatically revalidate or reissue the tickets. The system also rebooks Special Service Request (“SSR”) for passengers like Meal preference, Seat Preference as per the original flight sector. During manual rebooking process followed by airlines, the SSRs are not automatically moved when a flight is changed and has to be requested for each changed flight by the airline staff, but the tool will automatically move the requests for the new flight. The reissued tickets are sent by SMS or email to the customers. If the Airline has a policy that accommodation to be provided to passengers who have more than certain number of hours of waiting at departing city or at the transit city for connection due to disruption, the application will identify such passengers automatically and book them hotel as per airline policy. The other feature of the system is jurisdiction specific. For example, delayed flights arriving or departing from European Union (EU) requires compensation to be paid to passengers depending on the country of operation of the airline. The system automatically identifies the affected passengers, looks at the EU laws that is depending on the number of hours of delay and the duration of the flight and then calculates the penalty for each passenger. The tool also sends out a consolidated report on total penalties to be paid by the Airline. Further, if passengers are seeking complete refunds as the journey does not make sense for them—for example, for people attending 1-day seminar or conference, it does not make sense for them to travel after their business meeting is over. The tool now provides refund to such passengers as per the airline policies. Further, the Airport module of the system provides visibility to the Airport staff in having a real time report on the total number of passengers being booked, itineraries rebooked for each passenger, communication status to each passenger and many other reports and updates as required by Airlines ground staff at the airport to handle customers who are affected due to a disruption.

The other feature of the application is to provide a link to the customers when the rebooked flights are sent to them. If the automated rebooked flights are not convenient for them, they can click on the link and find alternate flights available at that point in time based on airlines policy for rebooking and make changes online without having to call an airline office.

The current system can be used in conjunction with several Global Distribution Systems and airline reservation systems such as Amadeus, Sabre, shares, TravelSky, SITA Horizon, etc. The current manual process of rebooking can take around 10 minutes or more per passenger, whereas the use of automated tool described here can rebook tickets in 10-20 seconds or so.

While the foregoing is directed to embodiments of the present invention, other and further embodiments of the invention may be devised without departing from the basic scope thereof, and the scope thereof is determined by the claims that follow.

What is claimed is:

1. A method to rebook passengers using an airline reservation system, comprising the steps of:
receiving a flight disruption event, like a delayed or cancelled flight;
prioritizing the passengers based on airline business rules;
collecting information on available flights to enable rebooking of affected passengers; and
rebooking the affected passengers based on defined business rules set out by the airlines,
so as to minimize the impact of flight disruptions on the Airline and affected passengers.

2. The method of claim 1, wherein prioritizing the affected passengers is based on parameters, such as class of service, FFP status, type of passenger, passengers requiring special handling.

3. The method of claim 1, wherein the collection of information is from several sources, such as Airline Reservation System, Hotel Reservations, Business rules and airline policies and communication platforms.

4. The method of claim 1, wherein the business rules for rebooking a ticket comprise of rules on passenger-class, origin and destination pair, airline availability, ticketing agreements between airlines.

5. The method of claim 1, wherein selection of airlines and respective class of booking is done as per policies laid down by the airline.

6. The method of claim 1, wherein rebooking is done based on alternate routing using transit city in the absence of direct flights.

7. The method of claim 1, wherein the passengers are rebooked to the nearest airport, in case airline has no flights to or is unable to operate to the final destination airport.

8. The method of claim 1, further comprising of information on rebooking and revalidated/reissued tickets and information related it to be sent to passenger and airline airport offices through all available modes such as Emails, Text Messages, Telephone Calls, Website and social media updating.

9. The method of claim 1, wherein SSRs are updated for all rebooked passengers as per the original booking.

10. The method of claim 1, wherein such rebooking is automatically done in continuous manner based on prioritization.

11. The method of claim 1, further comprising of rebooked tickets to be revalidated or reissued, as per the airline ticketing norms.

12. The method of claim 1, further comprising of calculation of compensating to the affected passengers based on jurisdictional laws, of such disrupted flight.

13. The method of claim 1, further comprising of ability to issue vouchers from airport for passengers for meals and use of lounges.

14. The method of claim 1, further comprising of providing a rebooking link to the customers along with newly booked flight details, so that they can amend the booking themselves without reaching out to an airline if the automated changes provided are not convenient for them.

15. A system to rebook passengers, comprising of:
an indicator to receive flight disruption events, like a delayed or cancelled flight;
a prioritization module that prioritize passengers based on the booking conditions for each passenger;
a logic engine to gather external parameters and business logic in order to enable rebooking of affected passengers; and
a rebooking module to rebook the affected passengers based on defined business rules set out by the airlines,
so as to minimize the impact of flight disruptions on the Airline and affected passengers.

16. The system of claim 14, wherein prioritization module is based on parameters, such as class of service, FFP status, type of passenger, passengers requiring special handling.

17. The system of claim 14, wherein the logic engine gathers information from several sources, such as Airline Reservation System, Hotel Reservations, Business rules and airline policies and communication platforms.

18. The system of claim 14, wherein the rebooking module consists of business rules for rebooking a ticket based on passenger-class, origin and destination pair, airline availability, ticketing agreements between airlines.

19. The system of claim 14, wherein rebooking module selects an airline and respective class of booking as per policies laid down by such airline.

20. The system of claim 14, wherein rebooking is done based on alternate routing using transit city in the absence of direct flights.

21. The system of claim 14, wherein the rebooking module books the passengers to the nearest airport, in case airline has no flights to or is unable to operate to the final destination airport.
